(19) United States
(12) Patent Application Publication
(10) Pub. No.: US 2005/0286052 A1
(43) Pub. Date: Dec. 29, 2005

(54) Elongated features for improved alignment process integration

(76) Inventors: Kevin Huggins, Hillsboro, OR (US); John H. Irby IV, Hillsboro, OR (US); Martin N. Weiss, Portland, OR (US); Alex W. Kay, Hillsboro, OR (US)

Correspondence Address: FISH & RICHARDSON, PC, 12390 EL CAMINO REAL, SAN DIEGO, CA, 92130-2081, US

(21) Appl. No.: 10/875,081

(22) Filed: Jun. 23, 2004

(51) Int. Cl. G01B 11/00

(52) U.S. Cl. 356/401

(57) ABSTRACT

Improved integration of alignment or overlay and other processes. A substrate may have one or more alignment features, which may be included in alignment marks or overlay features. Elongated features such as dummification features may be used near the alignment features. For example, line-shaped dummification features may be used in an alignment region, where light from an alignment process may interact with both the alignment features and the elongated features. The elongated features may be in the same layer or a different layer than the alignment features.

### BACKGROUND

Integrated circuits are manufactured by forming a sequence of patterned layers. One process that may be used in the manufacture of integrated circuits is a chemical mechanical polishing (CMP) process. A chemical mechanical polishing process uses chemical and physical interactions between a polishing system and the surface of a substrate (e.g., a wafer) to improve the planarity of the surface.

One concern in a CMP process is that the wafer be polished uniformly across its surface, so that the desired degree of planarity is obtained. However, areas of the substrate that have more features generally polish at different rates than areas having fewer features.

In order to reduce polishing non-uniformity, special features called “dummification” features may be added. FIG. 1 shows a dummification lattice 110 including regularly arrayed square features 120. These features may provide more uniform feature density but may not be needed for the actual circuit design. Dummification therefore may improve the uniformity of a CMP process. For example, the CMP process may be improved by more closely matching the density of the dummification area with its surroundings. However, features 110 may prove problematic when used near alignment features.

Alignment features are generally sets of parallel lines that are used by the lithography system to determine the proper alignment to a previous layer, so that a new layer may be patterned with the correct spatial relationship to previously patterned layers. The alignment features are detected using either bright field (video) alignment, or dark field (diffraction) alignment. With either of these schemes, features positioned near alignment features (such as dummification features 110) can interact with the alignment light and prevent proper detection of the alignment features. As a result, dummification is generally omitted in regions near alignment features.

### DESCRIPTION OF DRAWINGS

FIG. 1 is a lattice of dummification features.

FIG. 2 shows alignment features for single axis alignment.

FIG. 3A shows an alignment region with alignment features such as those shown in FIG. 2, with square dummification features included in the alignment region.

FIG. 3B shows a graph of normalized simulated contrast based on a configuration such as that shown in FIG. 3A.

FIG. 4A shows alignment features in a region free of dummification, according to the prior art.

FIG. 4B shows a graph of normalized simulated contrast based on a configuration such as that shown in FIG. 4A.

FIG. 5A shows elongated features that may provide improved integration of alignment and fabrication processes, according to an implementation.

FIG. 5B shows an implementation of alignment features and elongated dummification features, according to an implementation.

FIG. 5C shows a graph of normalized simulated contrast based on a configuration such as that shown in FIG. 5B.

FIG. 6A shows an implementation including a four zone dummification region.

FIG. 6B shows the implementation of FIG. 6A including a KLA overlay mark structure.

FIG. 7 is a cross sectional view of a periodic array of features.

FIG. 8A shows an implementation of elongated features that may be used with dark field alignment.

FIG. 8B shows an implementation of dummification features for a Nikon alignment system.

FIG. 8C shows an implementation of dummification features for an ASML alignment system.

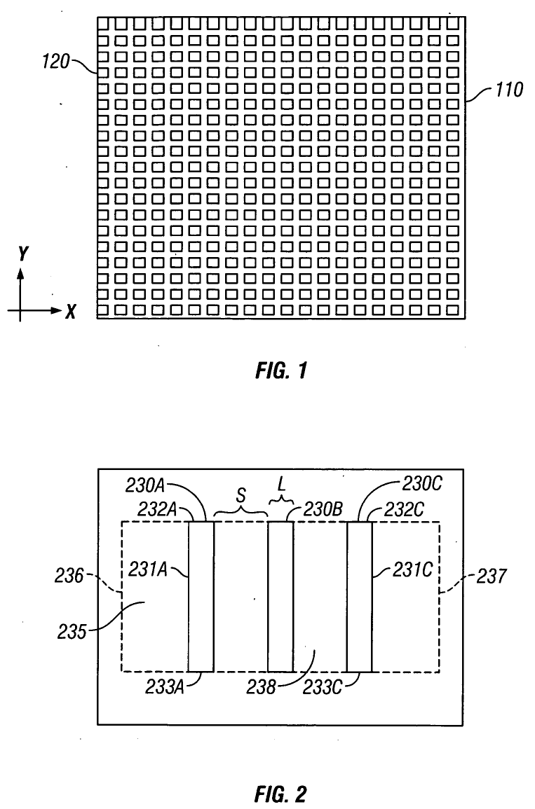

Like reference symbols in the various drawings indicate like elements.

### DETAILED DESCRIPTION

Systems and techniques described herein may allow for improved integration of alignment and fabrication processes.

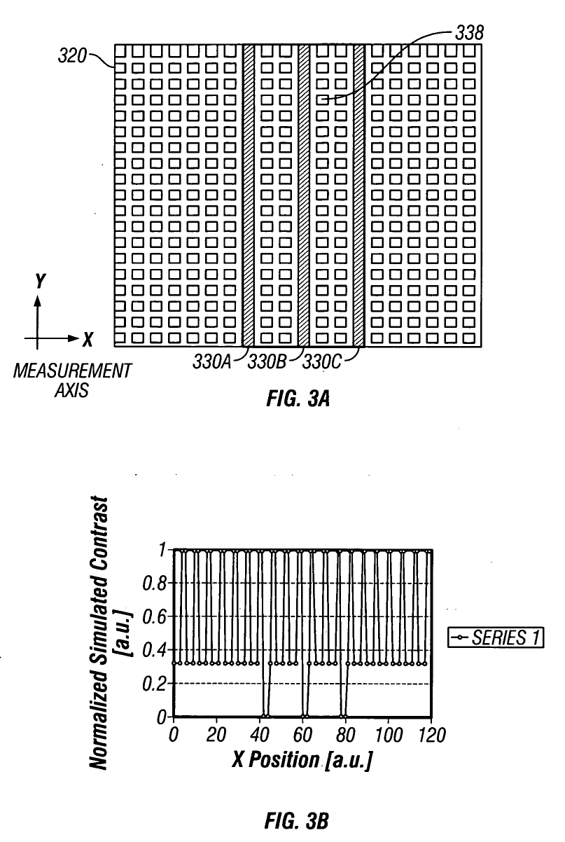

FIG. 2 shows an example of alignment features 230A to 230C (e.g., trenches) positioned near square dummification features 220. Alignment features 230A to 230C may be used to align a lithography system so that successive layers are patterned with the correct spatial relationship. Alignment features 230A to 230C have a line width L, which may be between about 0.1 micron to about 4 microns or more, and may be separated by a space having a width of about 4 to about 20 microns. Of course, many other line and space widths may be used.

In an alignment process, light is scanned along one or more measurement axes. Light interacts with features 230A to 230C and is detected in a detector. Other features near the alignment features may also interact with the alignment light, and may thus make detection of the alignment features more difficult.

Alignment features 230A to 230C may define an alignment region 238, which spans an area defined by outer edges 231A and 231C of features 230A and 230C, and further defined by a line extending from the top 232A of feature 230A to the top 232C of feature 230C and a line extending from the bottom 233A of feature 230A to the bottom 233C of feature 230C. Alignment region 238 extends to previous layers, as well as the layer in which the alignment features are formed. Features other than alignment features that are positioned within alignment region 238 (on the current layer, or in a previous layer) may interact with the alignment light and may therefore interfere with detection of the alignment features during an alignment process.

In some implementations, an extended alignment region 235 may be defined. Extended alignment region 235 is bordered on the top and bottom by the extension of the top and bottom border of alignment region 238, but is bordered on the left by a line 236 and on the right by a line 237. Line 236 may be a distance of about S to about 2 S from outer edge 231A, while line 237 may be a distance of between about S to about 2 S from outer edge 231C. Extended alignment region 235 also extends to previous layers. Features within extended alignment region 235 may also interact with alignment light and make it more difficult to detect the alignment features. For example, features within the portion of region 235 between line 236 and outer edge 231A may interfere with detection of the edge of an alignment mark.

Alignment may be accomplished using bright field (video) or dark field (diffraction) alignment. In bright field alignment, the alignment features are illuminated, and the alignment is determined using the detected image. In dark field alignment, coherent light (e.g., light from a laser source) is incident on the alignment features. A resulting diffraction pattern is detected and used to determine the alignment of the lithography system.

Alignment marks may be referred to as single axis or dual axis alignment marks. Single axis marks are used to align the lithography system in a single direction (e.g., the x or y direction). In order to align the system in both x and y (or equivalently, in two non-parallel directions, so that the two directions span the alignment plane), two single axis marks may be used. Dual axis alignment marks may be used to align the lithography system in two directions (e.g., the x and y directions, or other directions that span an alignment plane).

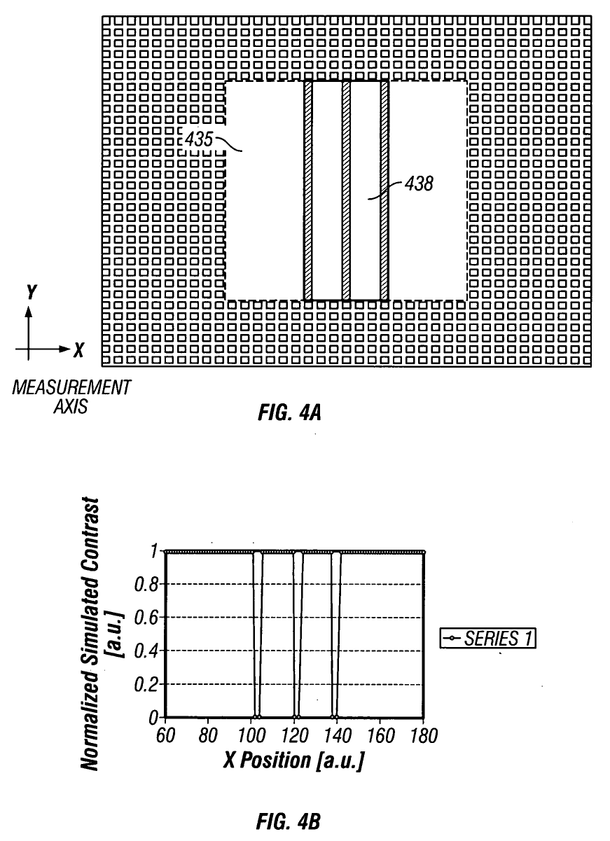

FIG. 3A shows an example where elongated alignment features include single axis bright field alignment trenches 330A to 330C, and where dummification features 320 are used near alignment features. In FIG. 3A, the light areas denote lines or elevated regions, while the darker areas denote depressed regions such as holes or trenches. Note that the term “near” applies not only to dummification features on the same layer as the alignment features, but also dummification features in previous layers. A dummification feature is “near” the alignment features if it is positioned so that, during an alignment process, it interacts with alignment light and generates light that may be received by a detector configured to detect alignment features.

For example, dummification features 320 are included in alignment region 338 (as well as outside of region 338). Dummification features 320 may be on the same layer as alignment trenches 330A to 330C, or on a different (e.g., previous) layer. Dummification features 320 within alignment region 338 may cause contrast variation that interferes with the ability to detect alignment features.

An example of this is shown in FIG. 3B. FIG. 3B shows a bright field contrast signal simulation of three alignment trenches such as trenches 330A to 330C of FIG. 3A superimposed onto a 50% dense square dummification lattice. The signal generated by the dummification lattice may make it more difficult to detect the position of the alignment marks than an alignment area devoid of dummification.

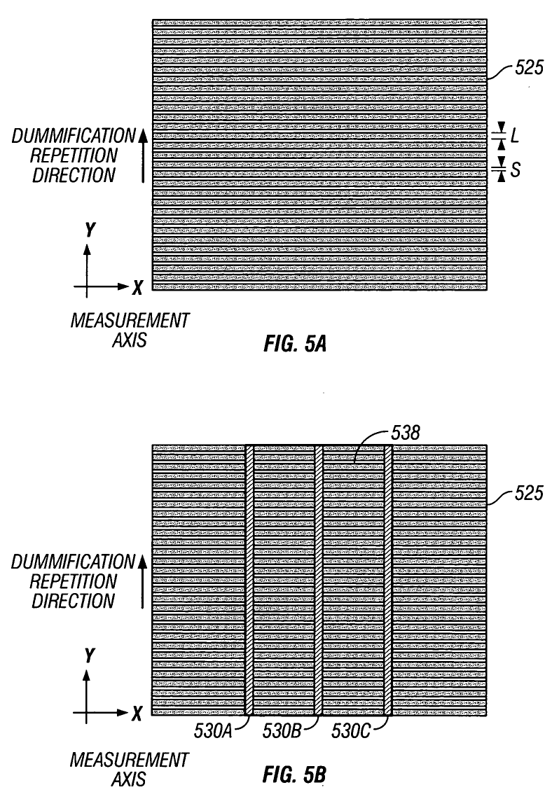

FIGS. 4A and 4B show a scheme to combat this problem. FIG. 4A shows an extended alignment region 435 that is free from dummification features. Note that in the implementation of FIG. 4A, region 435 is larger than alignment region 438, defined similarly to alignment region 238 of FIG. 2. That is, dummification is omitted for a region larger than that defined by the bounds of the alignment features themselves. FIG. 4B shows a bright field contrast signal simulation obtained by integrating the image of FIG. 4A in the y direction. As FIG. 4B illustrates, the contribution from the dummification regions may be reduced or eliminated by omitting dummification regions from being near the alignment features.

Although this allows for easier detection of the alignment features, it may create process integration problems due to issues of process variations. For example, a CMP process may cause region 435 to be polished more than surrounding regions, leading to dishing and other defects in region 435, and at the interface between region 435 and surrounding portions of the wafer.

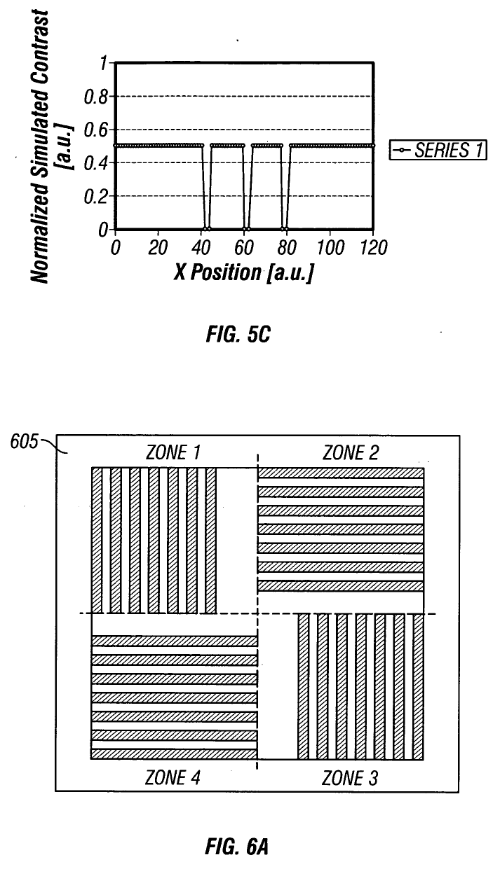

FIG. 5A shows an implementation of a plurality of elongated features 525 that allows for improved process integration without unduly compromising alignment feature detection. Note that although features 525 may be for dummification, the following description applies to other features that may be positioned near alignment features. However, in the following discussion features 525 are referred to as dummification features, since they may be used for dummification.

Dummification features 525 are elongated: that is, their long dimension (e.g., length) is greater than their short dimension (e.g., width). For example, the length of elongated dummification features may be at least three times that of the width. Of course, the ratio of long dimension to short dimension may be greater, e.g., ten to one. Dummification features may be line-shaped; therefore, the dummification may thus be referred to as line/space dummification.

At least a portion of one of a plurality of elongated features may be included in an alignment region. That is, at least a portion of dummification features 525 may be included in alignment region such as region 538 of FIG. 5B, which is defined similarly to that of region 238 of FIG. 2. In the implementation of FIG. 5A, the feature repetition direction is in the y direction, while the measurement axis is in the x direction. That is, the dummification repetition direction is orthogonal to the measurement axis.

FIG. 5B shows an implementation where three vertical trenches 530A to 530C are superimposed onto horizontal line/space dummification features 525. Of course, different numbers and configurations of alignment features may be used.

FIG. 5C shows a simulated bright field contrast signal that may be obtained with alignment features 530A to 530C and horizontal line/space dummification features 525 such as those shown in FIG. 5B. Rather than the intermittent signal generated with square dummification features, the background contrast signal generated from the dummification is generally constant. The signal may thus be amplified significantly without compromising signal quality. This allows alignment features that generate relatively weak signals to be used. Although the density of features 525 of FIG. 5A is 50%, other densities may be used. The amount of the contrast signal for densities other than 50% is different for different densities, but it is also generally constant. Therefore, the signal can be amplified without unduly compromising the ability to detect the alignment features.

Referring again to FIG. 5A, the width one of the dummification features 525 shown is denoted as L, while the width of a particular space between two successive dummification features 525 is denoted as S. Although FIG. 5A shows the line widths as all being equal, they need not be (e.g., for i lines, different values of Lᵢ may be used for different lines) Similarly, the widths of the spaces may vary. Although the widths of the lines and spaces may vary, the line density is generally selected to provide a desired feature density. For example, the line density may be selected so that the overall feature density near the alignment features more closely matches the surrounding pattern density of the layer is sufficient to obtain a desired level of planarity.

Note that the feature density near the alignment features and the pattern density are both generally discussed in terms of a particular window size. That is, the feature density is the percentage of the window that is spanned by features rather than space between features. The window size is selected to be large enough so that the determined density provides an accurate reflection of the overall density, while being small enough to reflect spatial variations in feature density.

Another type of alignment feature is an overlay feature. The objective of overlay measurements is to determine how well successive layers were aligned. In addition to aligning a lithography system, line/space dummification features such as features 525 of FIG. 5B may be used for overlay measurements. Overlay measurements are generally obtained using a registration tool, such as a registration tool manufactured by KLA-Tencor.

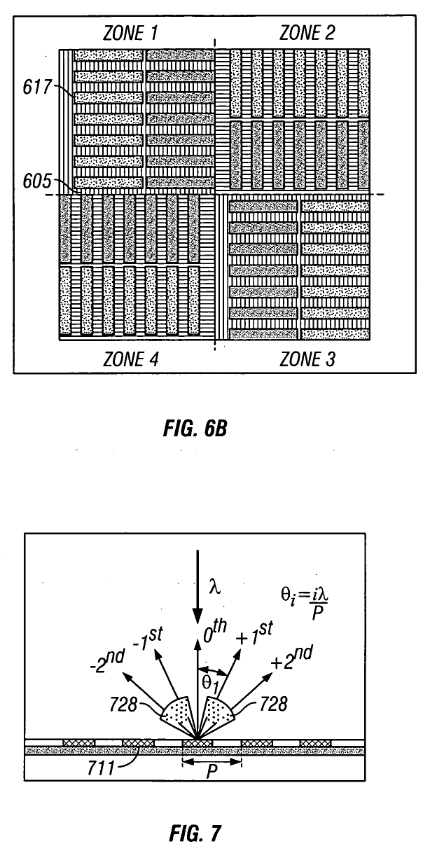

FIG. 6A illustrates an implementation in which a four-zone dummification region 605 is used. Region 605 may be patterned in a particular layer, and an overlay mark such as a KLA-Tencor Advanced Imaging Metrology (AIM) overlay mark may be patterned in a different layer above the layer including dummification region 605.

In order to measure overlay using region 605, the layer including region 605 is formed. The different layer including alignment features of the overlay mark is subsequently formed, so that the dummification repetition direction of each zone of region 605 is orthogonal to the overlay mark direction directly above the zone. Bright field contrast signals of the overlay structure may then be obtained and analyzed into four discreet regions corresponding to each zone. FIG. 6B illustrates both the four-zone dummification region 605 and an overlay mark structure (such as a KLA overlay structure) 617.

In some implementations, line/space dummification may be used with dark field alignment schemes. As noted above, the periodicity of currently used dummification schemes may create strong diffraction signals in both the x and y measurement directions, causing periodic constructive and destructive diffraction signals that may interfere with detection of the alignment feature diffraction signals if the signal-to-noise ratio is sufficiently low.

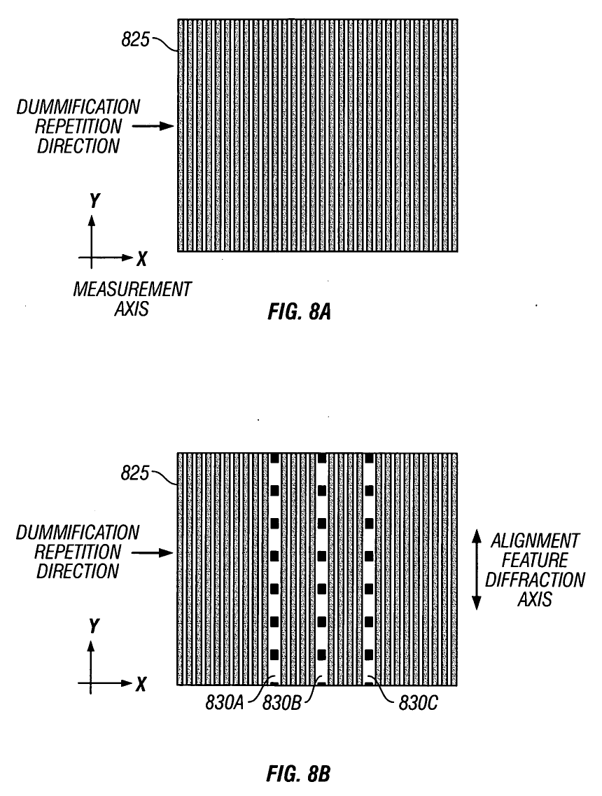

In a diffraction system, the i-th order scattering angle θᵢ=i*λ/P, where λ is the wavelength of incident light and P is the period of the scattering features. FIG. 7 is an illustration of a cross sectional view of a periodic array of scattering features 711 with a pitch P. Light from a coherent source is incident (e.g., at normal surface incidence), generating diffraction orders which are used for signal detection.

An example of a dark field system is a Nikon system, where the laser scan alignment (LSA) diffractive alignment system acquires the −2, −1, 1, and 2 orders, while the 0^{th} order is blocked by the detection system. Some Nikon systems are optimized for incident radiation of wavelength 632.8 nm, and features having a period of about eight microns. For example, the system may acquire the above diffraction orders by detecting light in detection regions 728. Scattering features having different periodicities positioned near the alignment features (e.g., in an alignment region defined similarly to region 238 or region 235 of FIG. 2) may generate detectable diffraction signals if the scattering angle falls within detection regions 728.

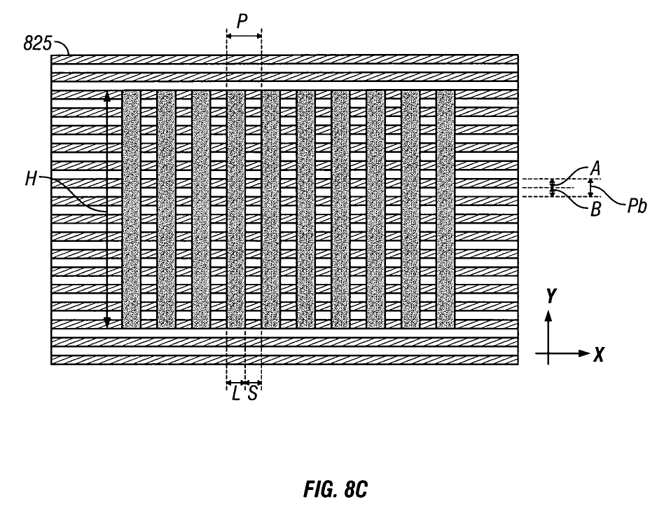

FIG. 8A shows an implementation of dummification features 825 that may be used with dark field alignment. In FIG. 8A, the dummification repetition direction is parallel to the measurement axis. Note that this is different than the bright field implementation, in which the measurement axis and repetition directions are orthogonal.

FIG. 8B shows an implementation of dummification features 825 for a Nikon LSA system. Three dark field alignment features 830A to 830C are superimposed onto a plurality of dummification features 825. In FIG. 8B, relatively depressed regions (e.g., trenches) are shown as grey, while relatively elevated regions (e.g., lines) are shown as white. The illustrated measurement axis and the dummification repetition are in the x direction, while the alignment feature diffraction axis is in the y direction. FIG. 8C shows an implementation of dummification features 825 for an ASML alignment mark. In FIG. 8C, the dummification repetition direction is in the y direction.

Alignment features such as those described above may be used as follows. For an implementation in which the alignment features are used to align a lithography system, light may be transmitted to one or more elongated alignment features (e.g., a plurality of line-shaped alignment features), where elongated dummification features are positioned near the alignment features. The light interacts with both the alignment features and the dummification features. However, because of the shape and relative orientation of the alignment and dummification features, the received light corresponding to the dummification features is a generally constant background signal.

The received light may then be analyzed to determine an alignment state of the lithography system. The position error of a portion of the lithography system relative to the alignment marks on the substrate may be determined and corrected by the lithography system during the exposure of the wafer to within acceptable limits.

For an implementation in which the alignment features are used to determine an overlay, light may be transmitted to one or more elongated alignment features (e.g., elongated alignment features included in an overlay mark), where elongated dummification features are positioned near the alignment features. Again, the light interacts with both the alignment features and the dummification features, but the contribution from the dummification features is generally constant. The received light may be analyzed and the overlay may be determined.

Both bright field and dark field schemes may be used with elongated dummification features. However, the relative orientation of the dummification features and alignment features depends on whether bright field or dark field alignment is being used.

A number of implementations have been described. Nevertheless, it will be understood that various modifications may be made without departing from the spirit and scope of the invention. For example, some variations in the angle and shape of the dummification features may be used. In general, there will be a desired signal to noise ratio, and some noise due to dummification features may be tolerated. Further, there may be a range of acceptable line/space densities for a particular layer design.

Also, while the above has described these techniques for use with the special “dummification” features, it should be understood that these techniques can be used with any semiconductor feature. Additionally, although the above description discussed dummification and alignment features patterned on a wafer, they may be incorporated into one or more semiconductor parts, such as masks, reticles, substrates, and the like. Accordingly, other implementations are within the scope of the following claims.

1. A method, comprising:
forming a plurality of elongated features on one or more semiconductor parts, the elongated features each having an associated long dimension and an associated short dimension, the associated long dimension greater than the associated short dimension; and
forming a plurality of alignment features on at least one of the one or more semiconductor parts, the plurality of alignment features to define an alignment region, the alignment region bordered in a plane by a first outer alignment feature and a second outer alignment feature and extending downward, wherein a portion of at least one of the plurality of elongated features is included in the alignment region.

2. The method of claim 1, wherein the elongated features include dummification features formed on a substrate.

3. The method of claim 1, wherein one or more of the plurality of elongated features is at least partially positioned between a first alignment feature and a second alignment feature.

4. The method of claim 1, wherein the plurality of alignment features are formed in a current layer, and wherein the one or more of the plurality of elongated features are formed in a previous layer.

5. The method of claim 1, wherein the elongated features are line-shaped.

6. The method of claim 5, wherein each of the elongated features has a corresponding line width, and wherein at least one of the elongated features has a corresponding line width different than a different one of the elongated features.

7. The method of claim 5, wherein adjacent elongated features are separated by a space having a corresponding space width.

8. The method of claim 7, wherein a first corresponding space width for a first pair of adjacent elongated features is different than a second corresponding space width for a second pair of adjacent elongated features.

9. The method of claim 1, wherein the alignment features are configured to determine an alignment parameter of a lithography system.

10. The method of claim 1, wherein the alignment features are configured to determine an overlay parameter.

11. The method of claim 1, wherein the one or more semiconductor parts include at least one of a mask, a reticle, and the substrate.

12. A method, comprising:
transmitting light to a plurality of elongated alignment features having a long dimension along a first axis and a short dimension, wherein the transmitted light interacts with the plurality of alignment features during an alignment process;
transmitting the light to a plurality of elongated features each having an associated long dimension along a long axis and an associated short dimension, wherein the light interacts with at least one of the plurality of elongated features during the alignment process;
receiving light that has interacted with the plurality of alignment features and light that has interacted with the plurality of elongated features as received light; and
determining an alignment parameter based on the received light.

13. The method of claim 12, wherein the received light has been reflected from at least one of the plurality of alignment features.

14. The method of claim 12, wherein the received light comprises diffracted light that has been scattered by at least one of the plurality of alignment features.

15. The method of claim 14, wherein the diffracted light comprises at least one non-zeroth order diffracted light.

16. The method of claim 12, wherein the long axis of the plurality of alignment features and the long axis of the plurality of elongated features are substantially parallel.

17. The method of claim 16, wherein the plurality of elongated features are formed in a lower layer of an integrated circuit than the plurality of alignment features.

18. The method of claim 12, wherein the long axis of the plurality of alignment features and the long axis of the plurality of elongated features are substantially perpendicular.

19. The method of claim 12, wherein the alignment parameter is indicative of an alignment of a lithography system.

20. The method of claim 12, wherein the alignment parameter is indicative of an overlay between a first layer and a second layer of a circuit structure.

21. The method of claim 12, wherein the elongated features include dummification features.

22. An apparatus, comprising:
one or more semiconductor parts having a plurality of alignment features, the plurality of alignment features defining an alignment region, the alignment region extending from an outer edge of a first outer alignment feature to an outer edge of a second outer alignment feature on a current layer, the alignment region extending downward to one or more previous layers;
one or more elongated features positioned on one of the one or more semiconductor parts, the one or more elongated features at least partially within the alignment region.

23. The apparatus of claim 22, wherein the one or more elongated features are at least partially included in the alignment region on the current layer.

24. The apparatus of claim 22, wherein the one or more elongated features are at least partially included in the alignment region on a previous layer.

25. The apparatus of claim 22, wherein the one or more elongated features have a length and a width, the length at least three times the width.

26. The apparatus of claim 22, wherein the one or more elongated features are line-shaped.

27. The apparatus of claim 26, wherein the plurality of alignment features are line-shaped.

28. The apparatus of claim 22, wherein the one or more elongated features are substantially parallel to the plurality of alignment features.

29. The apparatus of claim 27, wherein the one or more elongated features are substantially perpendicular to the plurality of alignment features.

30. The apparatus of claim 22, wherein the plurality of alignment features are included in an alignment mark.

31. The apparatus of claim 22, wherein the plurality of alignment features are included in an overlay structure.

32. The apparatus of claim 22, wherein the one or more semiconductor parts include at least one of a mask, a reticle, and a semiconductor substrate.

33. The apparatus of claim 22, further including a lithography system, and wherein the one or more semiconductor parts are included in a lithography system.
